(19) United States
(12) Patent Application Publication
(10) Pub. No.: US 2013/0202270 A1
(43) Pub. Date: Aug. 8, 2013

(54) METHOD AND APPARATUS FOR ACCESSING MULTIMEDIA CONTENT HAVING SUBTITLE DATA

(71) Applicants: Vineeth Neelakant, Bangalore (IN); Chetankumar Krishnamurthy, Bangalorc (IN)

(72) Inventors: Vineeth Neelakant, Bangalore (IN); Chetankumar Krishnamurthy, Bangalorc (IN)

(73) Assignee: NOKIA CORPORATION, Espoo (FI)

(21) Appl. No.: 13/807,570

(22) PCT Filed: Jun. 16, 2011
(86) PCT No.: PCT/FI2011/050578

§ 371 Date: Apr. 15, 2013

(30) Foreign Application Priority Data
Jun. 28, 2010 (IN) 1823/CHE/2010

(51) Int. Cl. H04N 9/87

(52) U.S. Cl. CPC H04N 9/87
USPC 386/244

(57) ABSTRACT

In accordance with an example embodiment a method and apparatus is provided. The method comprises enabling rendering of a rasterized image of at least one word in a subtitle data of a multimedia content. Further, the method comprises updating a count associated with the at least one word in the subtitle data for a portion of the multimedia content based on the rendering. Moreover, the method comprises updating information associated with the rasterized image of the at least one word in the subtitle data based on the count.

### TECHNICAL FIELD

Various implementations relate generally to method, apparatus, and computer program product for accessing multimedia content having subtitle data.

### BACKGROUND

Subtitles form a key aspect of multimedia content presentation. Subtitles help audience to view and understand multimedia content in different languages, as majority of multimedia devices have the capability to display subtitles along with audio and/or video content. Data associated with subtitles, hereinafter referred to as subtitle data is usually available as a separate track and/or stream with the audio and/or video content. The subtitle data may be available in several media file formats, including but limited to, mp4, Divx, and the like, on a multimedia storage medium such as a compact disk (CD), Digital Video Disk (DVD), flash drive, physical memory, memory cards, and the like.

A series of sections with start time and end time are defined in the subtitle data corresponding to the subtitles to be presented to a user. Such sections are defined to make sure that the subtitles and the audio and/or video content are synchronized at the time of presentation of the multimedia content. The subtitles for appropriate audio and/or video content are first rasterized, for example changed into rasterized images such as bitmaps formats, and overlaid on presentations of the audio and/or video on a display. As the playback of the multimedia content progresses over time, corresponding subtitles are fetched, rasterized and rendered on the display. Such process is repeated through out the playback of the multimedia content, making sure that the subtitles presented are in synchronization with the audio and/or video presentation. Such process creates a significant memory overhead for storing the rasterized images. Further, such process creates a lot of processing demands on the multimedia devices, as audio, video and subtitle data are handled together.

### SUMMARY OF SOME EMBODIMENTS

Various aspects of examples of the invention are set out in the claims.

In a first aspect, there is provided a method comprising enabling rendering of a rasterized image of at least one word in a subtitle data of a multimedia content; updating a count associated with the at least one word in the subtitle data for a portion of the multimedia content based on the rendering; and updating information associated with the rasterized image of the at least one word in the subtitle data based on the count.

In a second aspect, there is provided an apparatus comprising at least one processor; and at least one memory comprising computer program code, the at least one memory and the computer program code configured to, with the at least one processor, cause the apparatus to perform at least: enabling rendering of a rasterized image of at least one word in a subtitle data of a multimedia content; updating a count associated with the at least one word in the subtitle data for a portion of the multimedia content based on the rendering; and updating information associated with the rasterized image of the at least one word in the subtitle data based on the count.

In a third aspect, there is provided a computer program product comprising at least one computer-readable storage medium, the computer-readable storage medium comprising a set of instructions, which, when executed by one or more processors, cause an apparatus to perform at least: enabling rendering of a rasterized image of at least one word in a subtitle data of a multimedia content; updating a count associated with the at least one word in the subtitle data for a portion of the multimedia content based on the rendering; and updating information associated with the rasterized image of the at least one word in the subtitle data based on the count.

In a fourth aspect, there is provided a method comprising enabling rendering of a rasterized image of at least one word in a subtitle data of a multimedia content; and updating information related to the rendered rasterized image of the at least one word of the subtitle data based upon completion of playback a portion of the multimedia content.

In a fifth aspect, there is provided an apparatus comprising mean for enabling rendering of a rasterized image of at least one word in a subtitle data of a multimedia content; means for updating a count associated with the at least one word in the subtitle data for a portion of the multimedia content based on the rendering; and means for updating information associated with the rasterized image of at least one word in the subtitle data based on the count.

In a sixth aspect, there is provided a computer program comprising program instructions which when executed by an apparatus, cause the apparatus to perform enabling rendering of a rasterized image of at least one word in a subtitle data of a multimedia content; updating a count associated with the at least one word in the subtitle data for a portion of the multimedia content based on the rendering; and updating information associated with the rasterized image of the subtitle data based on the count.

### BRIEF DESCRIPTION OF THE FIGURES

For a more complete understanding of example embodiments of the present invention, reference is now made to the following descriptions taken in connection with the accompanying drawings in which:

FIG. 1 illustrates a device in accordance with an example embodiment;

FIG. 2 illustrates an apparatus in accordance with an example embodiment;

FIG. 3 illustrates an example of subtitle data for a portion of the multimedia content in accordance with an example embodiment;

FIG. 4 illustrates a schematic representation of scanning of the subtitle data for a portion of multimedia content, in accordance with an example embodiment;

FIG. 5 illustrates an example of a map in accordance with another example embodiment;

FIG. 6 is a flowchart depicting an example method for providing access to multimedia content having subtitle data in accordance with an example embodiment;

FIGS. 7A and 7B are a flowchart depicting an example method for providing access to multimedia content having subtitle data, in accordance with another example embodiment; and

FIG. 8 represents an example method for providing access to multimedia content having subtitle data in accordance with yet another example embodiment.

### DETAILED DESCRIPTION

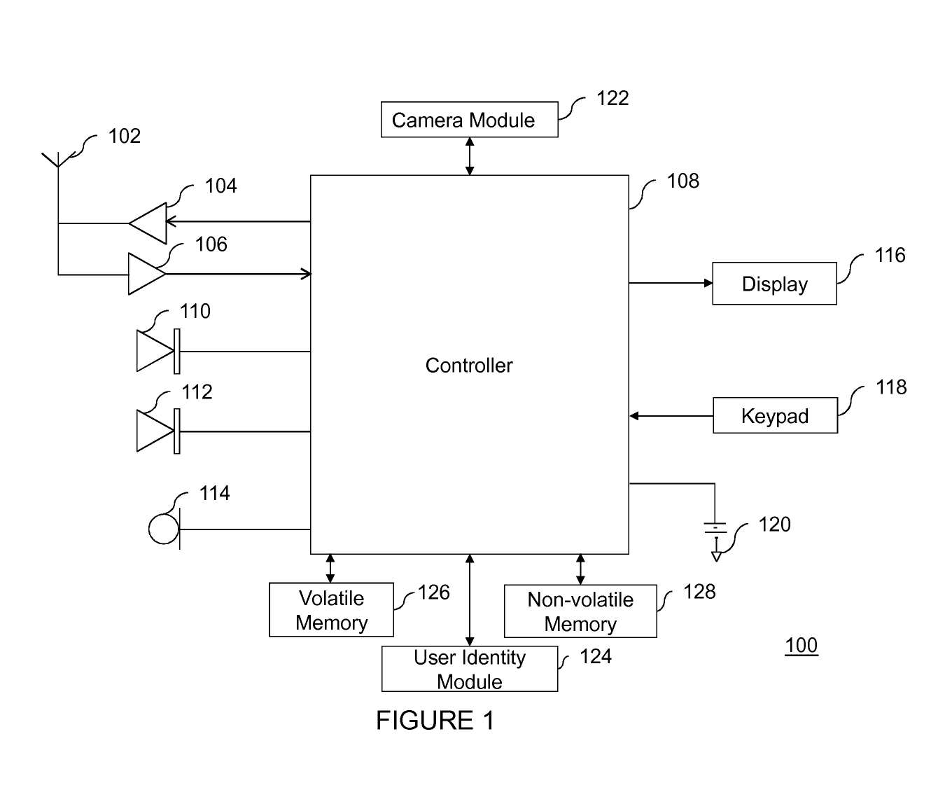

Example embodiments and their potential effects are understood by referring to FIGS. 1 through 8 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 of could be any of a number of types of mobile electronic devices such as, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software necessary for creating a digital image file from a captured image. Alternatively, the camera module 122 may include only the hardware needed to view an image, while a memory device of the device 100 stores instructions for execution by the controller 108 in the form of software to create a digital image file from a captured image. In an example embodiment, the camera module 122 may further include a processing element such as a co-processor which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile Random Access Memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

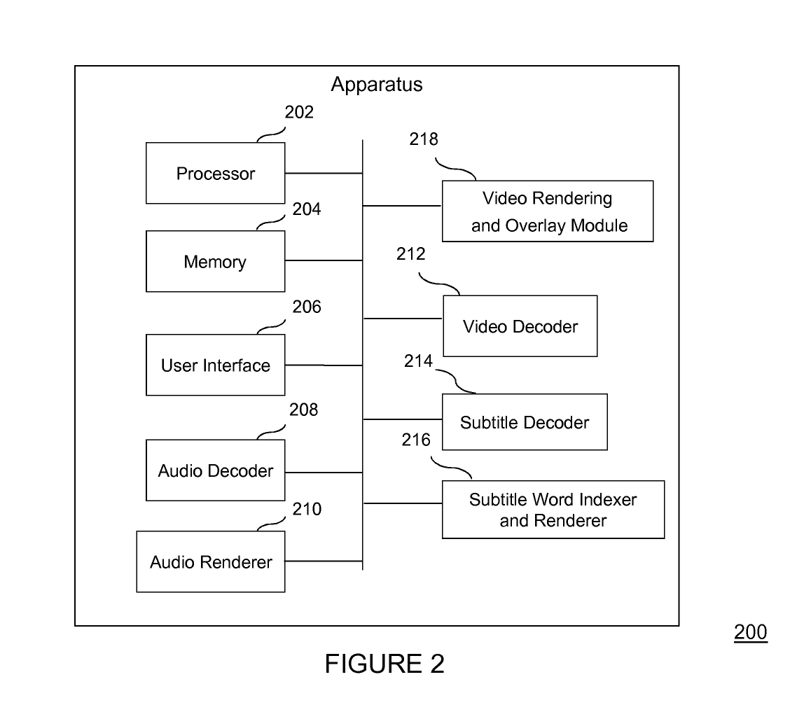

FIG. 2 illustrates an apparatus 200, in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively, embodiments may be employed on a combination of devices including, for example, those listed above. Accordingly, various embodiments may be embodied wholly at a single device, (for example, the device 100 or in a combination of devices. Furthermore, it should be noted that the devices or elements described below may not be mandatory and thus some may be omitted in certain embodiments.

In an example embodiment, the apparatus 200 may enable providing access to multimedia content having subtitle data. The apparatus 200 includes or otherwise is in communication with at least one processor 202, and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data for processing by the processor 202. Additionally or alternatively, the memory 204 may be configured to store instructions for execution by the processor 202.

The processor 202, which may be an example of the controller 108 of FIG. 1, may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. Thus, for example, when the processor 202 is embodied as two or more of an ASIC, FPGA or the like, the processor 202 may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206, include but are not limited to, input interface and/or output interface. The input interface 206 is configured to receive an indication of a user input. The output user interface provides an audible, visual, mechanical or other output and/or feedback to the user. Examples of the input interface 206 may include, but are not limited to, a keyboard, a mouse, a joystick, a keypad, a touch screen, soft keys, and the like. Examples of the input interface 206 may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, at least one memory 204, and/or the like, accessible to the processor 202.

In an example embodiment, the processor 202 is configured to, with the content of the memory 204, and optionally with other components described herein, to cause the apparatus 200 to provide access to the multimedia content having subtitle data. The apparatus 100 may receive the multimedia content from internal memory such as hard drive, random access memory (RAM) of the apparatus 200, or from external storage medium such as DVD, Compact Disk (CD), flash drive, memory card, or from external storage locations through Internet, Bluetooth®, and the like. The apparatus 100 may also receive the multimedia content from the memory 204. The multimedia content may include audio data, video data and subtitle data.

In an example embodiment, the processor 202 may be embodied as, include, or otherwise control, an audio decoder 208. The audio decoder 208 may be any mean such as a device or circuitry operating in accordance with software or otherwise embodied in hardware or a combination of hardware and software. For example, the processor 202 operating under software control, the processor 202 embodied as an ASIC or FPGA specifically configured to perform the operations described herein, or a combination thereof, thereby configures the apparatus or circuitry to perform the corresponding functions of the audio decoder 208. The audio decoder 208 receives audio data from the multimedia content, and decodes the audio data in a format that may be rendered by an audio renderer 210. The display may be an example of the display 116 and/or the user interface 206. In an example embodiment, the processor 202 may be embodied as, include, or otherwise control, the audio renderer 210. The audio renderer 210 may be any mean such as a device or circuitry operating in accordance with software or otherwise embodied in hardware or a combination of hardware and software which may render the audio output of the multimedia content. In an example embodiment, the audio renderer 210 may be the example of the speaker 112 in combination with accompanying drivers, software, firmware and/or hardware.

In an example embodiment, the processor 202 may be embodied as, include, or otherwise control, a video decoder 212. The video decoder 212 may be any mean such as a device or circuitry operating in accordance with software or otherwise embodied in hardware or a combination of hardware and software. For example, the processor 202 operating under software control, the processor 202 embodied as an ASIC or FPGA specifically configured to perform the operations described herein, or a combination thereof, thereby configures the apparatus or circuitry to perform the corresponding functions of the video decoder 208. The video decoder 212 receives video data from of the multimedia content and decodes the video data in a format that may be rendered at the display. For example, the video decoder 212 may convert the video data into a rasterized image, such as a bitmap format, to be rendered at the display. In an example embodiment, the video decoder 212 may convert the video data in a plurality of standard formats such as, for example, standards associated with H.261, H.262/MPEG-2, H.263, H.264, H.264/MPEG-4, MPEG-4, and the like.

In an example embodiment, the processor 202 may be embodied as, include, or otherwise control, a subtitle decoder 214. The subtitle decoder 214 may be any means such as a device or circuitry operating in accordance with software or otherwise embodied in hardware or a combination of hardware and software. For example, the processor 202 operating under software control, the processor 202 embodied as an ASIC or FPGA specifically configured to perform the operations described herein, or a combination thereof, thereby configures the apparatus or circuitry to perform the corresponding functions of the subtitle decoder 214. The subtitle decoder 214 receives a subtitle data from of the multimedia content and decodes the subtitle decoder in a format that may be rendered at the display. For example, the subtitle data may be in a format such as MPEG-4 Part 17, MicroDVD, universal subtitle format (USF), synchronized multimedia integration language (SMIL), SubStation Alpha (SSA), continuous media markup language (CMML), SubRip-format (SRT), and the like. In an example embodiment, the subtitle decoder may convert these file formats into a rasterized image format such as the bit map format, that may be rendered with the rendering of the associated video data.

In an example embodiment, the processor 202 may be embodied as, include, or otherwise control, a subtitle word indexer and renderer 216. The subtitle word indexer and renderer 216, hereinafter referred to as subtitle renderer 216, may be any mean such as a device or circuitry operating in accordance with software or otherwise embodied in hardware or a combination of hardware and software. For example, the processor 202 operating under software control, the processor 202 embodied as an ASIC or FPGA specifically configured to perform the operations described herein, or a combination thereof, thereby configures the apparatus or circuitry to perform the corresponding functions of the subtitle renderer 216. In an example embodiment, the processor 202 causes the subtitle renderer 216 to enable rendering of the rasterized image of at least one word in the subtitle data of the multimedia content. In an example embodiment, the processor 202 may be embodied as, include, or otherwise control, a video rendering and overlay module 218. The video rendering and overlay module 218 may be any mean such as a device or circuitry operating in accordance with software or otherwise embodied in hardware or a combination of hardware and software. For example, the processor 202 operating under software control, the processor 202 embodied as an ASIC or FPGA specifically configured to perform the operations described herein, or a combination thereof, thereby configures the apparatus or circuitry to perform the corresponding functions of the video rendering and overlay module 218.

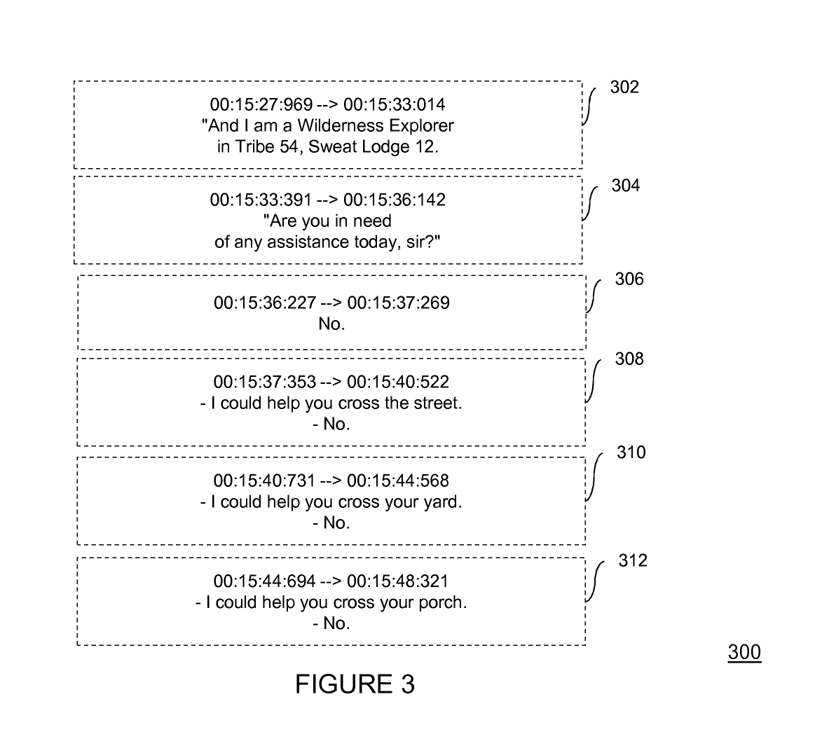

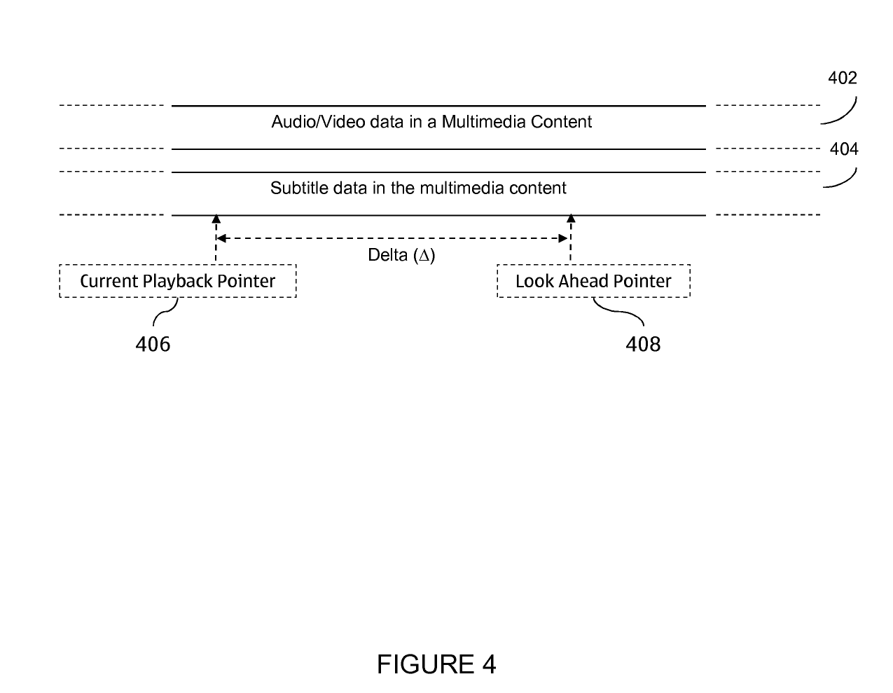

In an example embodiment, the processor 202 causes the video rendering and overlay module 218 to overlay the rasterized image of the at lease one word on a corresponding video frame and render the rasterized image and the video frame. In an example embodiment, the processor 202 causes the subtitle renderer 216 to update a count associated with the at least one word in the subtitle data for a portion of the multimedia content based on the rendering of the rasterized image. In an example embodiment, the processor 202 causes the subtitle renderer 216 to scan the subtitle data for the portion of the multimedia content to update the count associated with the at least one word in the subtitle data. In an example embodiment, the portion of the multimedia content comprises at least one of a scene of the multimedia content, a chapter of the multimedia content, group of frames of the multimedia content, logical time period of the multimedia content and a segment of the multimedia content having a predefined number of subtitle words. In an example embodiment, the group of frames may be the complete multimedia content. An example of subtitle data for a portion of the multimedia content is shown in FIG. 3. A schematic representation of scanning of the subtitle data for the portion of the multimedia content is shown in FIG. 4.

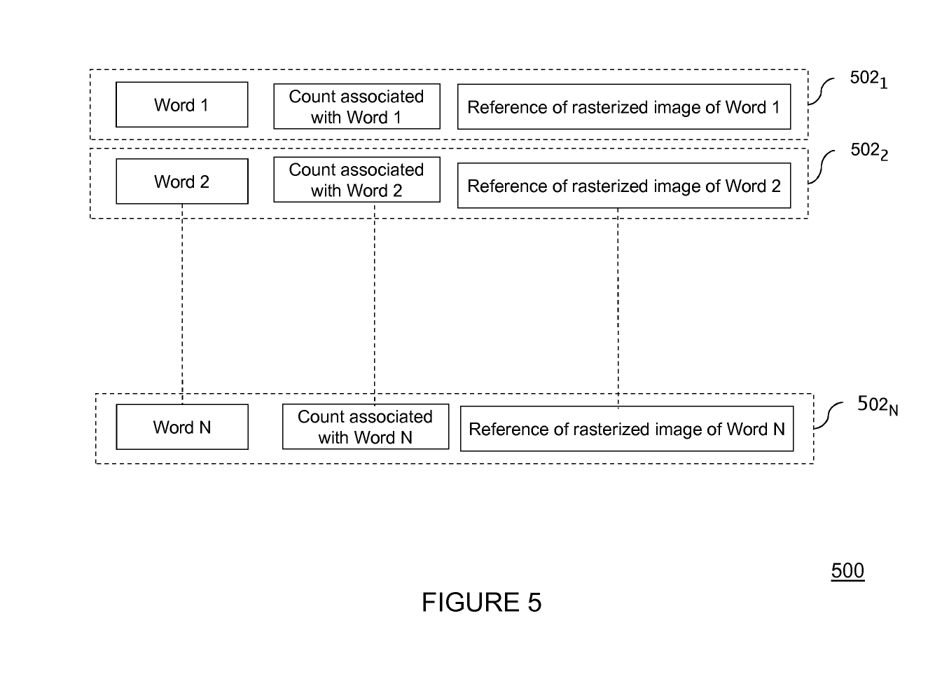

In an example embodiment, the processor 202 causes the subtitle renderer 216 to create an entry corresponding to the at least one word and the count associated with the at least one word in a map. In an example embodiment, the map may be stored in the memory 204 or any other storage location in the apparatus 200, or in any external storage location. In an example embodiment, the processor 202 also causes the subtitle renderer 216 to create a reference of the rasterized image of the at least one word in the map. An example of the map of is shown in FIG. 5.

In an example embodiment, for the portion of the multimedia content, the count associated with the at least one word may be updated in the corresponding entry depending upon the repetition of the at least one word in the subtitle data for the portion of the multimedia content. For example, if the word “John” repeats six times in the subtitle data, the count in the entry corresponding to the word “John” is increased by six.

In an example embodiment, if the word “John” is rendered once during a playback of the multimedia content, the processor 202 causes the subtitle renderer 216 to update the count associated with the word “John”. Accordingly, in an example, the count associated with “John” is decreased from six to five.

In an example embodiment, the processor 202 causes the subtitle renderer 216 to update information associated with the rasterized image based on the count associated with the at least one word. Herein, in an example embodiment, the information associated with the rasterized image includes reference of the rasterized image of the at least one word. For example, the information may be associated with a pointer for a memory location where the rasterized image is stored. In an example embodiment, if the count associated with the at least one word is less than a first threshold, the information may be updated by releasing the reference of the rasterized image of the at least one word, which in turn, releases the memory location where the rasterized image is stored. The released memory location may be used to store another rasterized image or for storing other data. In an example, if the value of the first threshold is two, and if the count associated with the word “John” is decreased to one, the reference of the rasterized image of the word “John” is released. In an example embodiment, the entry corresponding to the word “John” is also removed from the map. Further, at an instance when the word “John” is scanned in a subtitle data for a subsequent portion of the multimedia content, the rasterized image of the word “John” is regenerated and the entry corresponding to the word “John” is created in the map.

In an example embodiment, the processor 202 causes the subtitle renderer 216 to tag the at least one word if the count is greater than a second threshold. In an example embodiment, the processor 202 causes the subtitle renderer 216 to retain the reference of the at least one tagged word, irrespective of further changes in the count associated with the at least one tagged word. For example, if the value of the second threshold is ten and the count of the word “John” in the subtitled data for the portion of the multimedia content increases to eleven, the word “John” is tagged. Further, the reference of the rasterized image of the word “John” is retained even if the count associated with “John” reaches below the first threshold. Accordingly, in an example embodiment, the entry corresponding to the word “John” is also retained in the map.

In another example embodiment, the processor 202 causes the subtitle renderer 216 to update the information associated with the rasterized image by retaining references of a predetermined number of words of the at least one word. Such predetermined number of words may be chosen based on top ‘n’ number of words on the basis of their corresponding counts in the map.

FIG. 3 illustrates an example of a subtitle data 300 for a portion of the multimedia content, in accordance with an example embodiment. For example, the subtitle data 300 comprises data associated with dialogues in the portion of the multimedia content. The subtitle data 300 comprises timestamps associated with the dialogues and a group of words representing the dialogue. The timestamps are used to synchronize the rendering of the rasterized image of the subtitle data with the rendering of the corresponding video frames. For example, the rasterized image may be overlaid onto the corresponding rendered video frames depending upon the timestamp. As shown in FIG. 3, the subtitle data 300 for the portion of the multimedia content comprises dialogues between timestamps of [00:15:27:969] to [00:15:48:321]. The timestamps are shown in an example format of [hours:minutes:seconds:milliseconds] from a reference time so that the rasterized image of the subtitle data 300 may be synchronized with the corresponding video frames. The reference time may be [00:00:00:0000], a starting time of the first frame of the video frames. The subtitle data 300 comprises a first subtitle data 302 to be rendered between timestamps of [00:15:27:969] to [00:15:33:014], a second subtitle data 304 is to be rendered between the timestamps of [00:15:33:391] to [00:15:36:142], a third subtitle data 306 is to be rendered between the timestamps of [00:15:36:227] to [00:15:37:269], a fourth subtitle data 308 is to be rendered between the timestamps of [00:15:37:353] to [00:15:40:522], a fifth subtitle data 310 is to be rendered between the timestamps of [00:15:40:731] to [00:15:44:568], and a sixth subtitle data 312 is to be rendered between the timestamps of [00:15:44:694] to [00:15:48:321]. There may be other formats of the timestamp, for example, [hours:minutes:milliseconds], [hours:minutes:seconds], [hours, minutes,seconds,milliseconds] and the like.

In the subtitle data 300, the words such as “could”, “cross”, “your”, “help”, “No” occur with greater repetitions. Usually, within different portions such as scenes, chapters and/or logical group of frames in the multimedia content, some words repeat often, whereas some words generally do not repeat more often across different portions of the multimedia content. In an example embodiment, if the count associated with a particular word is less than the first threshold, reference of the rasterized image of the word may be released once the rasterized image of the word is rendered. In an example embodiment, if the count associated with a particular word increases more than the second threshold, the reference of the rasterized image of the word may be retained, even if the count associated with the word is less than the first threshold, as there may be significant possibility that word may be repeated in the subtitle data for the subsequent portions of the multimedia content.

FIG. 4 illustrates a schematic representation of scanning of the subtitle data for a portion of multimedia content, in accordance with an example embodiment. In an example embodiment, the subtitle data for the portion of the multimedia content is scanned to update the count associated with at least one word in the subtitle data. Schematic representations of audio/video data 402 in the multimedia content, and subtitle data 404 in the multimedia content are shown in FIG. 4. A current playback pointer 406, and a look ahead pointer 408 may be initialized once a command of playback of the multimedia content is received in the apparatus. In an example embodiment, the playback pointer 406 points to a part of the audio/video data that is currently being rendered, (played back), in an apparatus such as the apparatus 200. Further, the subtitle data in a delta (Δ) segment is scanned for determining counts of words present in the delta (Δ) segment of the subtitle data 404. In an example embodiment, the delta (Δ) may be maintained as constant, as the playback counter 406 and the look ahead pointer 408 may advance simultaneously. In an example embodiment, the delta (Δ) may be decided depending on factors such as next n seconds or next m words in the subtitle data 404. In an example embodiment, at the time of initialization, the playback pointer 406 and the look ahead pointer 408 may be started at a same spatial point of the subtitle data 404. Further, the look ahead pointer 408 is advanced to a point when the look ahead pointer 408 maintains spatial distance of the delta (Δ) with the playback pointer 406. In an example embodiment, the portion of the multimedia content may be covered by the delta (Δ). In an example embodiment, during the scan by the look ahead pointer 408, words of the subtitle data 404 that are already not present in the map, are added. Further, the count associated with the word is also incremented based on repetition of the word.

FIG. 5 illustrates an example of a map 500, in accordance with an embodiment. The map 500 comprises entries comprising words of the subtitle data, and counts associated with the words. In an example embodiment, the entries also comprise references of the rasterized images of the words. For example, the map 500 includes an entry 502₁ comprising “word 1”, the count associated with the “word 1”, and the reference of the rasterized image of the “word 1”. Similarly, an entry 502₂ comprises “word 2”, the count associated with the “word 2”, and the reference of the rasterized image of the “word 2”, and so on, as an entry 502_{N} comprises “word N”, the count associated with the “word N”, and the reference of the rasterized image of the “word N”. In an example embodiment, the map 500 may also include tags for words that have their counts more than the second threshold, at any instant, during the scan by the look ahead pointer 408 in the portion of the multimedia content. In an example embodiment, there may be a flag such as a binary bit, that may be set to ‘0’ or ‘1’, if the word is tagged. In another example embodiment, the map 500 may include a separate list of entries for the words that have their counts more than the second threshold, at any instant, during the scan by the look ahead pointer 408 in the portion of the multimedia content.

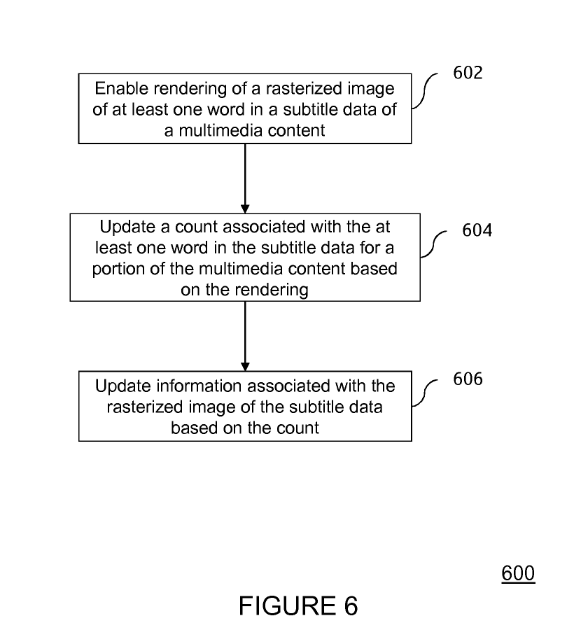

FIG. 6 is a flowchart depicting an example method for providing access to multimedia content having subtitle data, in accordance with an example embodiment. The method depicted in flow chart may be executed by, for example, the apparatus 200 of FIG. 2.

At block 602, rendering of a rasterized image of at least one word in a subtitle data of a multimedia content is enabled. At block 604, a count associated with the at least one word in the subtitle data for a portion of the multimedia content is updated based on the rendering. In an embodiment, the portion of the multimedia content may be at least one of a scene of the multimedia content, a chapter of the multimedia content, a group of frames of the multimedia content, a logical time period of the multimedia content, and a segment of multimedia content having a predefined number of subtitle words. In an example embodiment, the group of frames of the multimedia content may comprise the complete multimedia content.

At block 606, information associated with the rasterized image of the subtitle data is updated based on the count. In an example embodiment, the updating the information associated with the rasterized image comprises releasing a reference of the rasterized image of the at least one word if the count associated with the at least one word in a map such as the map 500, is less than a first threshold. In another example embodiment, updating the information associated with the rasterized image comprises retaining references of one or more words of the at least one word, if the count associated with the at least one word is greater than a second threshold. In this embodiment, if the count associated with a particular word increases more than the second threshold, the particular word is tagged in the map, and the reference of the rasterized image of the word is retained. In another example embodiment, updating the information associated with the rasterized image comprises retaining references of a predetermined number of words of the at least one word. In an example format, if the reference of the at least one word is released, and the at least one word is scanned again in a subsequent portion of the multimedia content, the rasterized image of the at least one word is generated and the entry corresponding to the at least one word is created in the map.

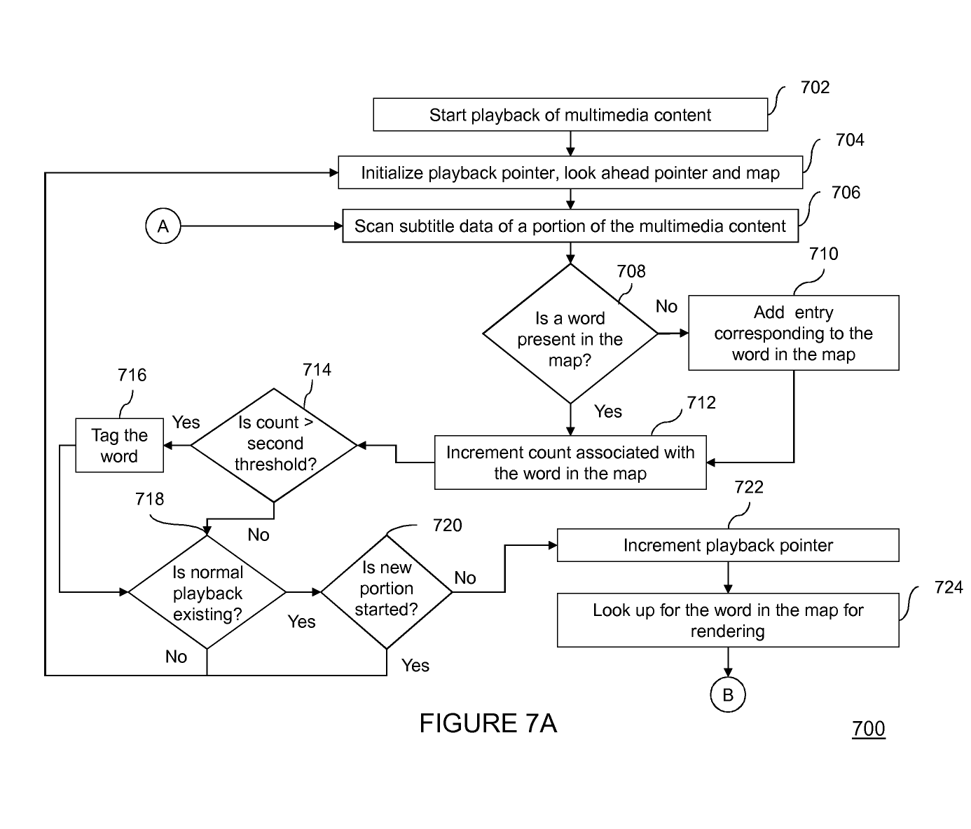

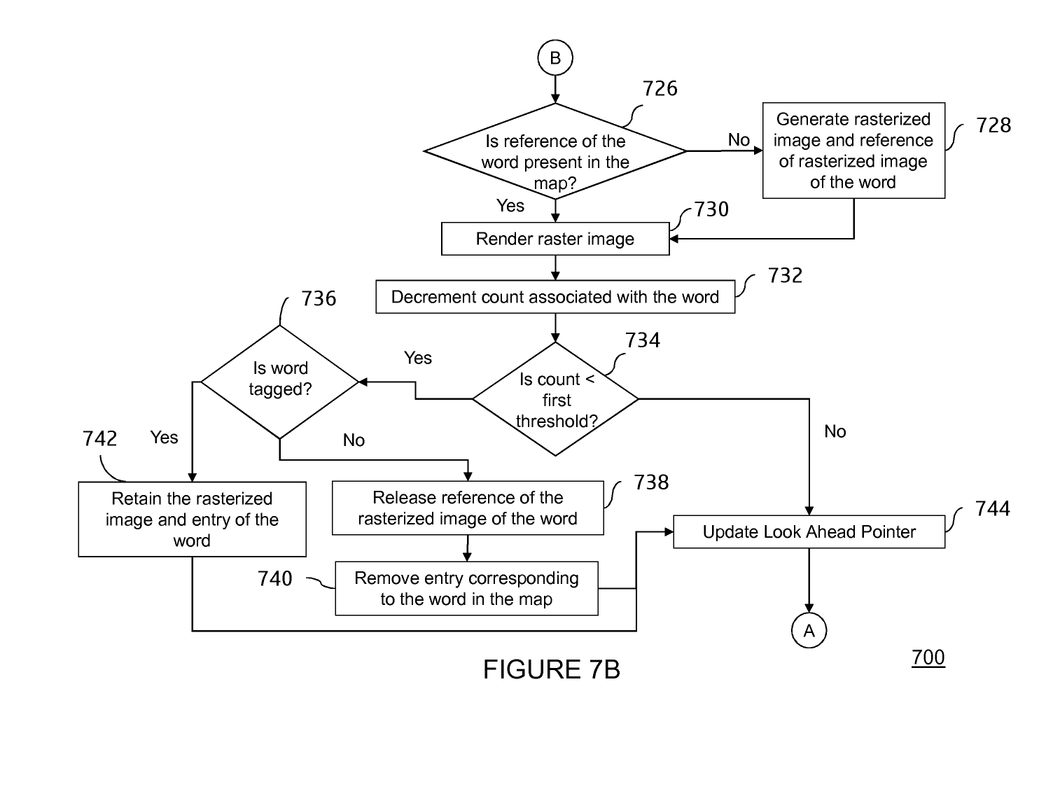

FIGS. 7A and 7B are a flowchart depicting an example method 700 for providing access to multimedia content having subtitle data, in accordance with another example embodiment. The method 700 depicted in flow chart may be executed by, for example, the apparatus 200 of FIG. 2. Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 700 are described with help of apparatus 200. However, the operations of the method may be described and/or practiced by using any other apparatus.

At block 702, playback of the multimedia content is started. At block 704, a playback pointer, a look ahead pointer and a map are initialized. The playback pointer and the look ahead pointer may be examples of the playback pointer 406 and the look ahead pointer 408, respectively. The map may be an example of the map 500. At block 706, the subtitle data for the portion of the multimedia content is scanned. The portion of the multimedia content may be defined between the playback pointer and the look ahead pointer, covered by the delta (Δ), as depicted in FIG. 4. In an example embodiment, the portion of the multimedia content is scanned for determining a repetition of at least one word present in the subtitle data for the portion of the multimedia content.

At block 708, it is determined that whether an entry corresponding to the word is already present in the map. If it is determined that the entry corresponding to the word is not present in the map, the entry corresponding to the word is created in the map at block 710, and a count associated with the word is incremented in the map, at block 712. However, if it is determined that the entry is already present in the map, a count associated with the word is incremented in the map, at block 712. In an example embodiment, at block 714, it is determined whether the count associated with the word is greater than the second threshold. If it is determined that the count associated with the word is greater than the second threshold, the word is tagged at block 716, in an example embodiment. The word may be tagged by setting a flag in the corresponding entry of the word in the map. In another example embodiment, if is determined that the count associated with the word is greater than the second threshold, instead of tagging the word, the word may be put in a secondary map or in the separate list of entries in the map.

At block 718, it is determined whether a normal playback process is existing. If the normal playback process is existing, it is further determined whether a playback of a new portion of the multimedia content is started, at block 720. If the normal playback process does not exist, or if the playback of the new portion of the multimedia content is started (such as after a seek operation on the multimedia content), the operation of the block 704 is performed, for example, the playback pointer, the look ahead pointer and the map are initialized.

At block 720, if it is determined that the new portion of the multimedia content is not started, the playback pointer is incremented at block 722. At block 724, an entry corresponding to the word is looked up in the map for rendering of the rasterized image of the word. At block 726, it is determined whether a reference of the rasterized image of the word is present in the map. If the reference is not present in the map, rasterized image of the word is generated, at block 728. In an example embodiment, the rasterized image is stored in a memory where rasterized images of the subtitle data of the multimedia content are typically stored. In an example embodiment, a reference of the rasterized image of the word, is also generated in the map. In an example embodiment, the reference of the rasterized image of the word may be added in the corresponding entry of the word in the map.

If at block 726, it is determined that reference of the rasterized image is present in the map, the rasterized image is rendered, at block 730. In an example embodiment, the rasterized image is rendered by overlaying the rasterized image onto the corresponding video frame during a playback of the multimedia content. Once the rasterized image of the word is rendered, the count associated with the word is decreased at block 732. For example, if the count associated with the word is ‘five’, and the rasterized image of the word is rendered once during the playback of the multimedia content, the count associated with the word may be decremented to ‘four’.

In an example embodiment, at block 734, the count associated with the word is compared to the first threshold. In an example embodiment, if the count associated with the word is determined to be less than the first threshold, it is determined whether the word is tagged, at block 736. In an example embodiment, the value of the first threshold is zero. However, in an alternate embodiment, the value of the first threshold may be more than zero. If it is determined that the word is not tagged, the reference of the rasterized image of the word may be released at block 738. In an example embodiment, at block 740, the entry corresponding to the word is also removed from the map. However, if at block 736, it is determined that the word is tagged, reference of the rasterized image of the word is retained in the map at block 742. In an example embodiment, the entry corresponding to the word is also retained in the map, if the word is determined as tagged. At block 744, the look ahead pointer is updated. In an example embodiment, as the look ahead pointer is updated, at least one new word is scanned in the subtitle data for the portion of the multimedia content at block 706.

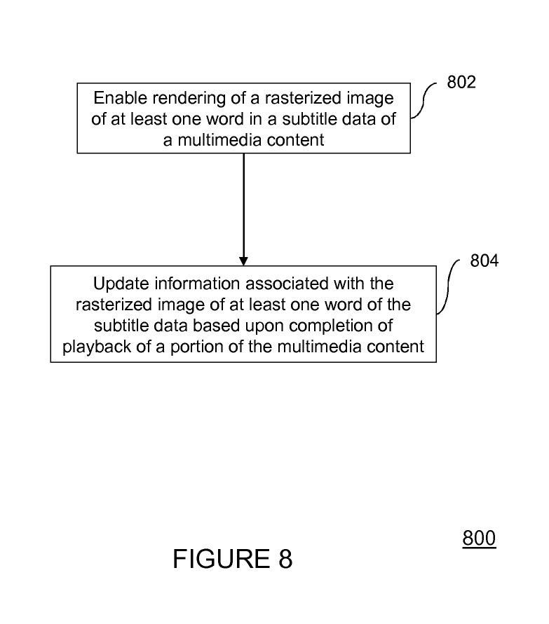

FIG. 8 represents an example method 800 for providing access to multimedia content having subtitle data in accordance with yet another example embodiment. The method 800 depicted in flow chart may be executed by, for example, the apparatus 200 of FIG. 2.

At block 802, rendering of a rasterized image of at least one word in a subtitle data of a multimedia content is enabled. At block 804, information associated with the rendered rasterized image of the subtitle data is updated based upon completion of playback a portion of the multimedia content. In an example embodiment, the portion of the multimedia content comprises at least one of a scene of the multimedia content, a chapter of the multimedia content, a group of frames of the multimedia content, a logical time period of the multimedia content, and a segment of multimedia content having a predefined number of subtitle words. In an example embodiment, the group of frames of the multimedia content may include the complete multimedia content.

In this example embodiment, the reference of the rasterized image of the at least one word is released, once the playback of the portion of the multimedia content is completed.

Without in any way limiting the scope, interpretation, or application of the claims appearing below, a technical effect of one or more of the example embodiments disclosed herein is to utilize repetition of words in the subtitle data within portions of the multimedia content such as scenes, chapters and other such logical grouping. The spatial proximity of these repeating words is used to model the storage of the rasterized images. Various methods described herein determine the count of words within scenes or chapters. This determined count is used to control the replacement of rasterized images from the storage of the rasterized images.

References of the rasterized images of words that repeat with high frequency within a scene or chapter are retained, as there are higher possibility of these words repeating across scenes & chapters. Further, the words, which may not occur later or may occur only after a considerable amount of time, their corresponding rasterized images are discarded at the end of the playback of the scene, chapter or any such logical grouping. Such methods provide apparatuses to access retain and discard references of rasterized images in a memory efficient manner.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that may contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that may contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1. A method comprising:
enabling rendering of a rasterized image of at least one word in a subtitle data of a multimedia content;
updating a count associated with the at least one word in the subtitle data for a portion of the multimedia content based on the rendering; and
updating information associated with the rasterized image of the at least one word in the subtitle data based on the count.

2. (canceled)

3. The method of claims 1 further comprising creating an entry, in a map, corresponding to the at least one word and the count associated with the at least one word.

4. The method of claim 3 further comprising creating a reference of the rasterized image of the at least one word in the map, wherein the rasterized image is rendered during a playback of the multimedia content based on the reference.

5. The method of claim 3, wherein updating the count associated with the at least one word comprises decreasing the count in the entry in the map upon rendering of the rasterized image of the at least one word.

6. The method of claim 3, wherein updating the information associated with the rasterized image comprises releasing the reference of the rasterized image of the at least one word if the count associated with the at least one word in the map is less than a first threshold; and
removing the entry corresponding to the at least one word from the map.

7. (canceled)

8. The method of claim 5 further comprising:
tagging the at least one word if the count is greater than a second threshold, wherein updating the information associated with the rasterized image comprises retaining the reference of the rasterized image of the at least one tagged word in the map; and retaining an entry corresponding to the at least one tagged word in the map.

9. (canceled)

10. The method of claim 5, wherein updating the information associated with the rasterized image comprises retaining references of a predetermined number of words of the at least one word in the map.

11. (canceled)

12. (canceled)

13. An apparatus comprising:
at least one processor; and
at least one memory comprising computer program code, the at least one memory and the computer program code configured to, with the at least one processor, cause the apparatus to perform at least:
enable rendering of a rasterized image of at least one word in a subtitle data of a multimedia content;
update a count associated with the at least one word in the subtitle data for a portion of the multimedia content based on the rendering; and
update information associated with the rasterized image of the at least one word in the subtitle data based on the count.

14. (canceled)

15. The apparatus of claims 13, wherein the apparatus is further caused, at least in part, to create an entry, in a map, corresponding to the at least one word and the count associated with the at least one word.

16. The apparatus of claim 15, wherein the apparatus is further caused, at least in part, to create a reference of the rasterized image of the at least one word in the map, wherein the rasterized image is rendered during a playback of the multimedia content based on the reference.

17. The apparatus of claim 15, wherein the apparatus is further caused, at least in part, to update the count associated with the at least one word by decreasing the count in the entry in the map upon rendering of the rasterized image of the at least one word.

18. The apparatus of claim 16, wherein the apparatus is further caused, at least in part, to update the information associated with the rasterized image by releasing the reference of the rasterized image of the at least one word if the count associated with the at least one word in the map is less than a first threshold; and
to remove the entry corresponding to the at least one word from the map.

19. (canceled)

20. The apparatus of claim 17, wherein the apparatus is further caused, at least in part, to tag the at least one word if the count is greater than a second threshold, wherein updating the information associated with the rasterized image comprises retaining the reference of the rasterized image of the at least one tagged word in the map; and
to retain an entry corresponding to the at least one tagged word in the map.

21. (canceled)

22. The apparatus of claim 17, wherein the apparatus is further caused, at least in part, to update the information associated with the rasterized image by retaining references of a predetermined number of words of the at least one word in the map.

23. (canceled)

24. (Canceled)

25. A computer program comprising a set of instructions, which, when executed by one or more processors, cause an apparatus to perform at least:
enable rendering of a rasterized image of at least one word in a subtitle data of a multimedia content;
update a count associated with the at least one word in the subtitle data for a portion of the multimedia content based on the rendering; and
update information associated with the rasterized image of the at least one word in the subtitle data based on the count.

26. (canceled)

27. The computer program of claim 25, wherein the apparatus is further caused, at least in part, to create an entry, in a map, corresponding to the at least one word and the count associated with the at least one word.

28. The computer program of claim 27, wherein the apparatus is further caused, at least in part, to create a reference of the rasterized image of the at least one word in the map, wherein the rasterized image is rendered during a playback of the multimedia content based on the reference.

29. The computer program of claim 27, wherein the apparatus is further caused, at least in part, to update the count associated with the at least one word by decreasing the count in the entry in the map upon the rendering of the rasterized image of the at least one word.

30. The computer program of claims 28, wherein the apparatus is further caused, at least in part, to update the information associated with the rasterized image by releasing the reference of the rasterized image of the at least one word if the count associated with the at least one word in the map is less than a first threshold; and
to remove the entry corresponding to the at least one word from the map.

31. (canceled)

32. The computer program of claim 29, wherein the apparatus is further caused, at least in part, to tag the at least one word if the count is greater than a second threshold, wherein updating the information associated with the rasterized image comprises retaining the reference of the rasterized image of the at least one tagged word in the map; and to retain an entry corresponding to the at least one tagged word in the map.

33-43. (canceled)
